(19) United States
(12) Patent Application Publication
(10) Pub. No.: US 2026/0312535 A1
(43) Pub. Date: Oct. 8, 2026

(54) CABLE-STORAGE-TYPE PHOTOVOLTAIC MODULE JUNCTION BOX

(71) Applicant: XI'AN THERMAL POWER RESEARCH INSTITUTE CO., LTD., Xi'an, Shaanxi (CN)

(72) Inventors: Xiaojun XIE, Xi'an (CN); Yousheng ZHU, Xi'an (CN); Yong ZHAO, Xi'an (CN); Bo TONG, Xi'an (CN); Zichen SONG, Xi'an (CN); Baofeng ZHANG, Xi'an (CN); Bin HAN, Xi'an (CN)

(73) Assignee: XI'AN THERMAL POWER RESEARCH INSTITUTE CO., LTD., Xi'an, Shaanxi (CN)

(21) Appl. No.: 19/484,567

(22) PCT Filed: Jul. 16, 2024
(86) PCT No.: PCT/CN2024/105718

§ 371 Date: Nov. 14, 2025

(30) Foreign Application Priority Data
Aug. 30, 2023 (CN) 202311101470.2

(51) Int. Cl. H02S 40/34; H01H 23/14; H01H 23/16; H01R 13/72; H01R 24/28; H01R 24/76

(52) U.S. Cl. CPC H02S 40/34; H01H 23/143; H01H 23/162; H01R 13/72; H01R 24/28; H01R 24/76

(57) ABSTRACT

A cable-storage-type photovoltaic module junction box, which comprises a housing, a switch component, a cable storage component and a photovoltaic module connecting electrode component. In the junction box in the present application, there is no reserved cable after the cable is connected, such that a power station is neat and aesthetic in appearance; the cable is not reserved outside after a photovoltaic module is connected, such that a potential safety hazard present in conventional cables is avoided, and the service life of the cable can also be greatly prolonged; the cable is properly stored, and thus the problem of a plug colliding with a backplate of the module during module production and transportation processes is avoided, such that the problem of a hidden crack caused by the module being impacted is avoided.

### CROSS-REFERENCE TO RELATED APPLICATIONS

This application claims the priority of the Chinese patent application filed with the China National Intellectual Property Administration on Aug. 30, 2023, with the application number 202311101470.2 and the invention title “CABLE-STORAGE-TYPE PHOTOVOLTAIC MODULE JUNCTION BOX”, the entire content of which is incorporated into this application by reference.

### TECHNICAL FIELD

The present application relates to the technical field of photovoltaic power generation, and more particularly, relates to a cable-storage-type photovoltaic module junction box.

### BACKGROUND ART

A photovoltaic module is the core device for photovoltaic power generation, and its main components include glass, a frame, battery cells, EVA/POP, a backplate, and a junction box. Among them, the junction box is an outlet device for the positive and negative lead-out wires of the photovoltaic module, mainly consisting of a housing 1, an electrode 2, a diode 3, a cable 4, and a male-female plug 5, as shown in FIG. 1. Its main function is to connect photovoltaic modules to form series or parallel connections. Due to the large size of photovoltaic modules, and the junction box is generally installed in the middle or on both sides of the intermediate component, the connection between photovoltaic modules requires a relatively long cable, which however leads to a series of problems. For example, after the modules are connected, there is still a surplus of cables, resulting in the need to bundle the excess cables or bury them in the bracket grooves at the photovoltaic power station site. On the one hand, this causes cable waste; on the other hand, excessive bending of the cables leads to damage to the cable insulation; moreover, the site is not neat and aesthetically pleasing. Another example is that due to the excessive length of the cables, the swinging of the cables during production, transportation, installation, and maintenance will cause the male-female plug to hit the back of the module. Since the solar cells are very thin and fragile, such collisions will cause hidden cracks in the cells, affecting the quality of the module.

### SUMMARY

The present application aims to provide a cable-storage-type photovoltaic module junction box to overcome the deficiencies existing in the prior art.

To solve the above technical problems, the technical solution of the present application is: a cable-storage-type photovoltaic module junction box, including a housing, a switch component, a cable storage component, and a photovoltaic module connection electrode component.

As an optional embodiment of the cable-storage-type photovoltaic module junction box of the present application, the housing includes a main housing, a cover body, and an internal partition. The main housing is provided with a first slot for fixing the photovoltaic module connection electrode component, a second slot for fixing the copper bar of the switch component, a third slot for fixing the cable storage component, positive and negative busbar inlets of the photovoltaic module, and reinforcing ribs; the cover body is provided with a cable outlet, a cable socket, a connection port of the switch component, and a fixing slot; the internal partition is provided with a socket port and heat dissipation grilles.

As an optional embodiment of the cable-storage-type photovoltaic module junction box of the present application, the switch component includes a switch rotating shaft, a handle kit, a long connecting rod, a short connecting rod, a copper bar electrode, a long isolating knife, a short isolating knife, and a flexible connection cable; one end of the long connecting rod and one end of the short connecting rod are both connected to the switch rotating shaft, and the other end of the long connecting rod is connected to the short isolating knife, while the other end of the short connecting rod is connected to the long isolating knife, respectively; the handle kit is sleeved on the switch rotating shaft; one end of the flexible connection cable is connected to the copper bar electrode, and the other end of the flexible connection cable is connected to the long isolating knife and the short isolating knife, respectively.

As an optional embodiment of the cable-storage-type photovoltaic module junction box of the present application, the long isolating knife is composed of a first electrode and a long push-pull rod; one end of the long push-pull rod is provided with a first slotted hole for connecting with the short connecting rod; the short isolating knife is composed of a second electrode and a short push-pull rod; one end of the short push-pull rod is provided with a second slotted hole for connecting with the long connecting rod.

As an optional embodiment of the cable-storage-type photovoltaic module junction box of the present application, the cable storage component includes an outer shell and a retractable cable drum; the outer shell includes a shell body and a cover plate, both of the shell body and the cover plate are made of insulating materials; the retractable cable drum includes a drum shell, a cable, a volute spring, a spring cover plate, a shaft, and a rotating electrode; one end of the cable is connected to the rotating electrode, and the other end is provided with a plug; the rotating electrode is a hollow rotatable member, and both ends of the hollow rotatable member are provided with leaf spring slots; the drum shell is provided with a cable outlet and a fixing port for the volute spring; the shell body is provided with a fourth slot for installing the shaft, a fixed shaft for installing the switch component, and a first limit slot and a second limit slot for limiting the stroke of the long push-pull rod and the short push-pull rod in the switch component.

As an optional embodiment of the cable-storage-type photovoltaic module junction box of the present application, the photovoltaic module connection electrode component includes a socket electrode, a diode, and a welding electrode; one end of the diode is connected to the socket electrode, and the other end of the diode is connected to the welding electrode; the socket electrode is composed of an outer shell, an electrode, and a spring electrode sheet; the outer shell is provided with a fifth slot for connecting with the main housing.

Compared with the prior art, the beneficial effects of the present application are as follows: the junction box of the present application has no reserved cables after cable connection, making the appearance of the power station neat and beautiful; since there are no cables reserved outside after the photovoltaic modules are connected, the potential safety hazards of conventional cables are avoided, and the service life of the cables can also be greatly improved; due to the good storage of the cables, there is no problem of plugs colliding with the backplate of the modules during the production and transportation of the modules, avoiding the problem of hidden cracks caused by collision of the modules; the junction box of the present application has a shutdown function, making it safer and more convenient during module maintenance; the junction box of the present application is universal for both positive and negative poles of the modules; the junction box of the present application has a cable storage function, and the cable is inside the cable drum, and the cable can be pulled out according to the actual connection length.

### BRIEF DESCRIPTION OF THE DRAWINGS

In order to more clearly illustrate the technical solutions in the embodiments of the present application or the prior art, the accompanying drawings required for describing the embodiments or the prior art will be briefly introduced below. Obviously, the accompanying drawings in the following description are only some embodiments recorded in the present application. For those of ordinary skill in the art, other accompanying drawings can also be obtained based on these drawings without making creative efforts.

FIG. 1 is a structural schematic diagram of the background art;

FIG. 2 is a schematic diagram of the connection structure between the junction box and the photovoltaic panel;

FIG. 3 is a cross-sectional view of the junction box in a switch-disconnected state;

FIG. 4 is a cross-sectional view of the junction box in a switch-connected state;

FIG. 5 is an exploded view of the junction box;

FIG. 6 is an exploded view of the housing;

FIG. 7 is a structural schematic diagram of the main housing;

FIG. 8 is a structural schematic diagram of the cover body;

FIG. 9 is a structural schematic diagram of the internal partition;

FIG. 10 is an exploded view of the switch component;

FIG. 11 is a structural schematic diagram of the long isolating knife and the short isolating knife;

FIG. 12 is an exploded view of the cable storage component;

FIG. 13 is a sub-view one of the cable storage component;

FIG. 14 is a sub-view two of the cable storage component;

FIG. 15 is a structural schematic diagram of the shell;

FIG. 16 is a structural schematic diagram of the photovoltaic module connection electrode component; and

FIG. 17 is a front cross-sectional view (a) and a left cross-sectional view (b) of the socket electrode.

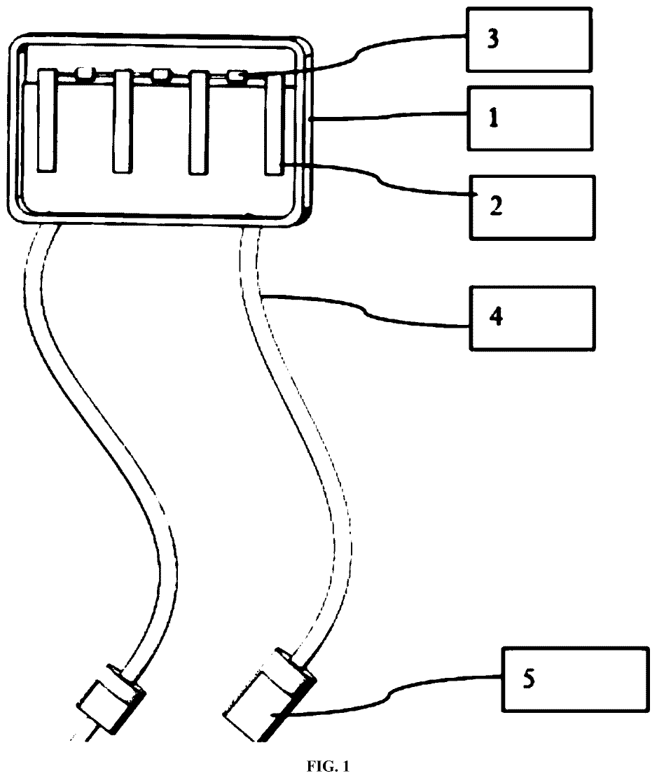

Among them, 1. housing; 11. main housing; 111. first slot; 112. second slot; 113. third slot; 114. busbar inlet; 115. reinforcing rib; 12. cover body; 121. cable outlet; 122. cable socket; 123. connection port; 124. fixing slot; 13. internal partition; 131. socket port; 132. heat dissipation grille;

2. switch component; 21. switch rotating shaft; 22. handle kit; 23. long connecting rod; 24. short connecting rod; 25. copper bar electrode; 26. long isolating knife; 261. first electrode; 262. long push-pull rod; 2621. first slotted hole; 27. short isolating knife; 271. second electrode; 272. short push-pull rod; 2721. second slotted hole; 28. flexible connection cable;

3. cable storage component; 31. outer shell; 311. shell; 3111. fourth slot; 3112. fixed shaft; 3113. first limit slot; 3114. second limit slot; 312. cover plate; 32. retractable cable drum; 321. drum shell; 3211. cable outlet; 3212. fixing port; 322. cable; 3221. plug; 323. volute spring; 324. spring cover plate; 325. shaft; 326. rotating electrode; 3261. leaf spring slot;

4. photovoltaic module connection electrode component; 41. socket electrode; 411. outer shell; 412. electrode; 413. spring electrode sheet; 414. fifth slot; 42. diode; 43. welding electrode.

### DETAILED DESCRIPTION OF THE EMBODIMENTS

The following will clearly and completely describe the technical solutions in the embodiments of the present application with reference to the accompanying drawings in the embodiments of the present application. Obviously, the described embodiments are only a part of the embodiments of the present application, rather than all the embodiments. Based on the embodiments in the present application, all other embodiments obtained by those of ordinary skill in the art without making creative efforts shall fall within the protection scope of the present application.

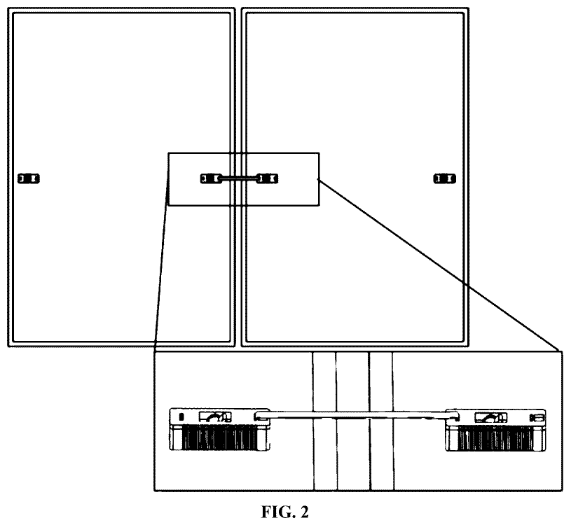

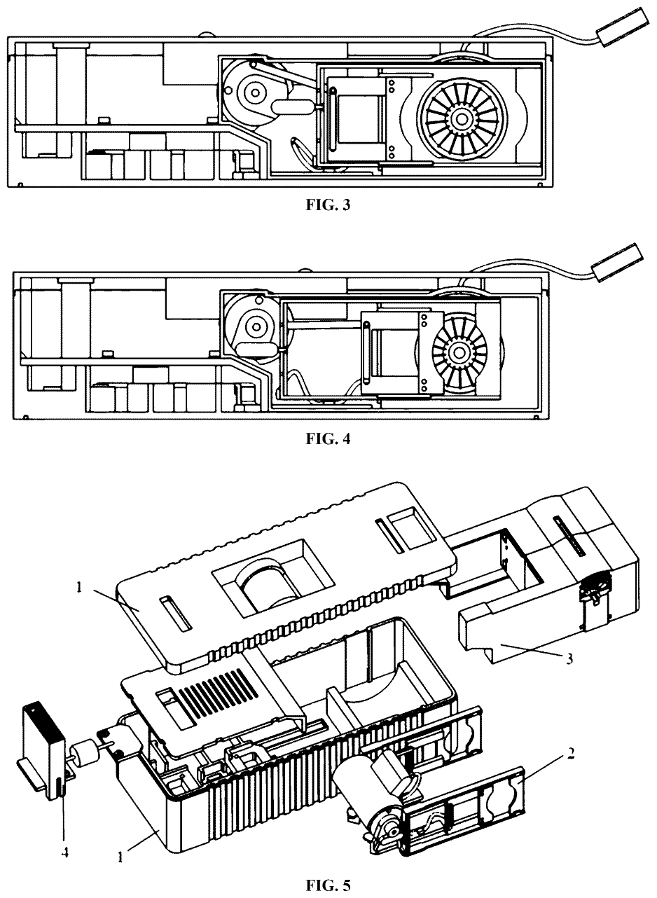

As shown in FIGS. 2 to 4, a cable-storage-type photovoltaic module junction box includes a housing 1, a switch component 2, a cable storage component 3, and a photovoltaic module connection electrode component 4.

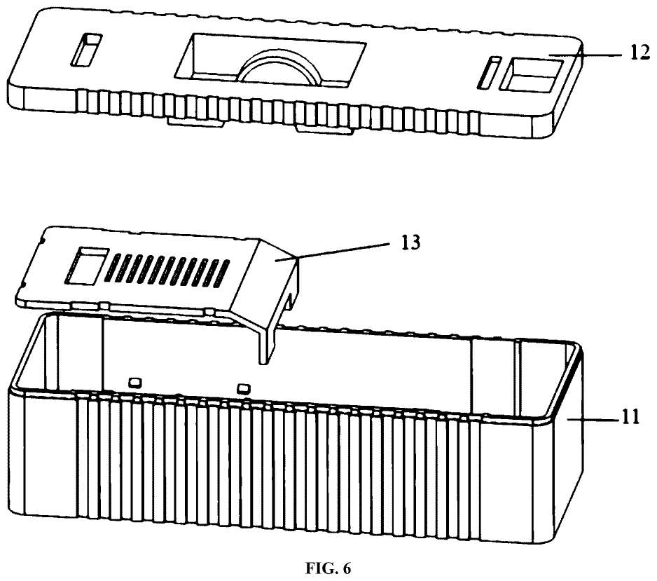

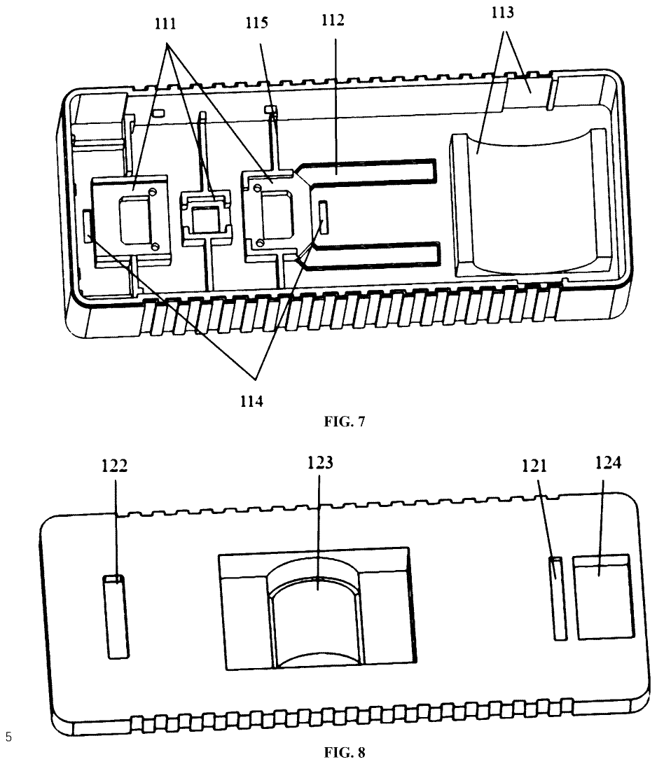

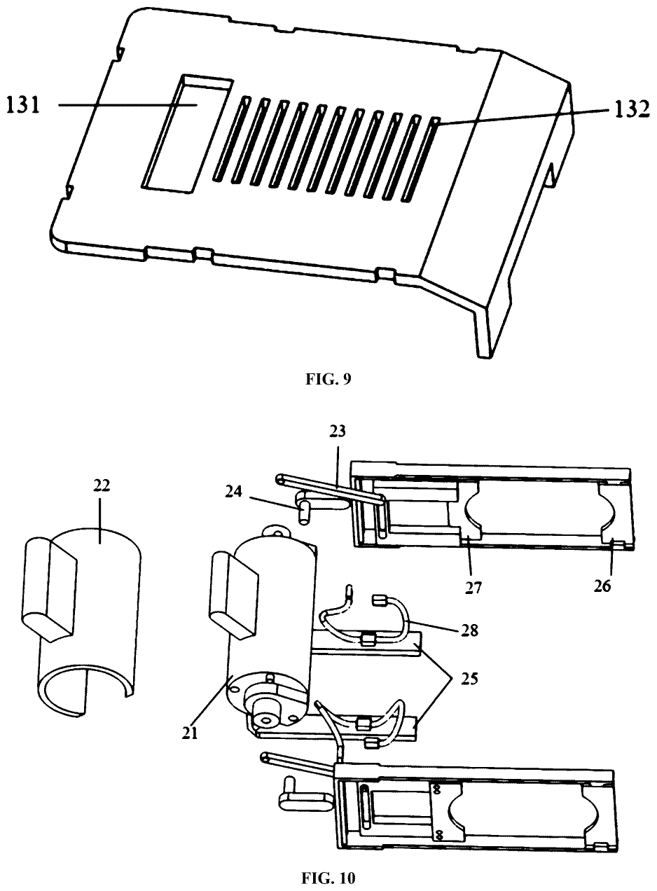

As shown in FIGS. 5 to 9, the housing 1 includes a main housing 11, a cover body 12, and an internal partition 13. The main housing 11 is provided with a first slot 111 for fixing the main housing 11, a second slot 112 for fixing the copper bar of the switch component 2, a third slot 113 for fixing the cable storage component 3, positive and negative busbar inlets 114 of the photovoltaic module, and reinforcing ribs 115; the cover body 12 is provided with a cable outlet 121, a cable socket 122, a connection port 123 of the switch component 2, and a fixing slot 124; the internal partition 13 is provided with a socket port 131 and heat dissipation grilles 132.

The switch component 2 includes a switch rotating shaft 21, a handle kit 22, a long connecting rod 23, a short connecting rod 24, a copper bar electrode 25, a long isolating knife 26, a short isolating knife 27, and a flexible connection cable 28; one end of each of the long connecting rod 23 and the short connecting rod 24 is connected to the switch rotating shaft 21, and the other end of each of the long connecting rod 23 and the short connecting rod 24 is connected to the short isolating knife 27 and the long isolating knife 26, respectively; the handle kit 22 is sleeved on the switch rotating shaft 21; one end of the flexible connection cable 28 is connected to the copper bar electrode 25, and the other end of the flexible connection cable 28 is connected to the long isolating knife 26 and the short isolating knife 27, respectively.

The long isolating knife 26 is composed of a first electrode 261 and a long push-pull rod 262; one end of the long push-pull rod 262 is provided with a first slotted hole 2621 for connecting with the short connecting rod 24; the short isolating knife 27 is composed of a second electrode 271 and a short push-pull rod 272; one end of the short push-pull rod 272 is provided with a second slotted hole 2721 for connecting with the long connecting rod 23.

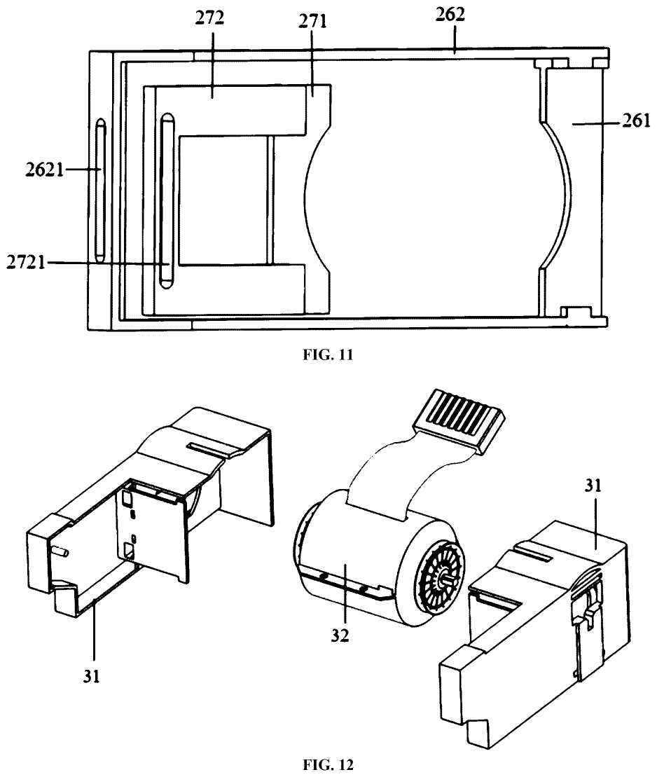

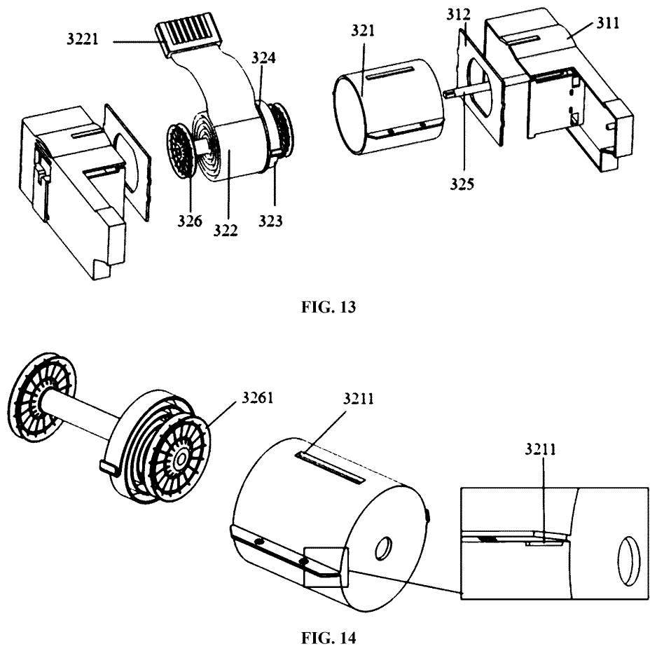

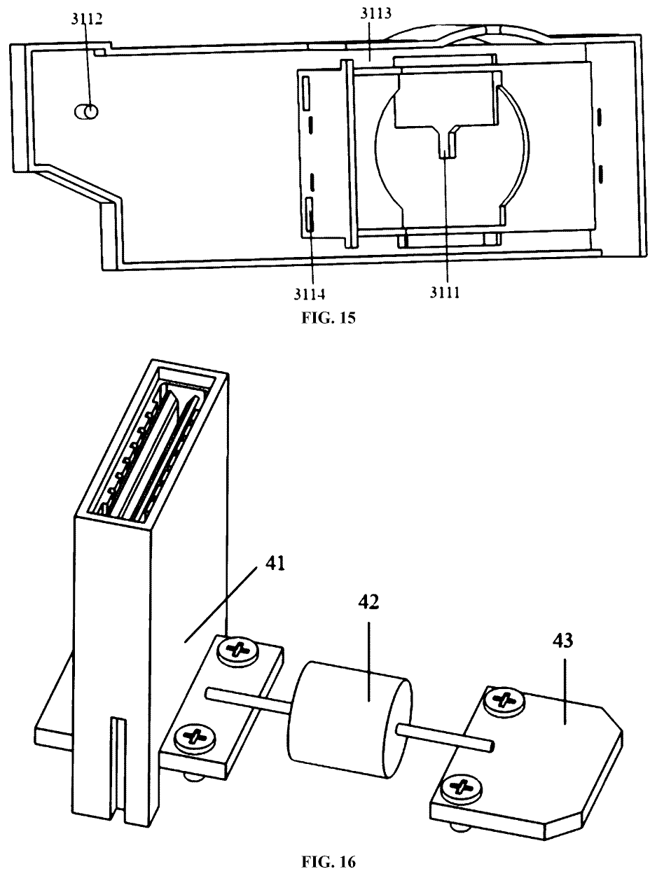

As shown in FIGS. 10 to 15, the cable storage component 3 includes an outer shell 31 and a retractable cable drum 32; the outer shell 31 includes a shell 311 and a cover plate 312, both of which are made of insulating materials; the retractable cable drum 32 includes a drum shell 321, a cable 322, a volute spring 323, a spring cover plate 324, a shaft 325, and a rotating electrode 326; one end of the cable 322 is connected to the rotating electrode 326, and the other end is provided with a plug 3221; the rotating electrode 326 is a hollow rotatable member, and both ends thereof are provided with leaf spring slots 3261; the drum shell 321 is provided with a cable outlet 3211 and a fixing port 3212 for the volute spring 323; the shell 311 is provided with a fourth slot 3111 for installing the shaft 325, a main housing 110 for installing the switch component 2, and a first limit slot 3113 and a second limit slot 3114 for limiting the stroke of the long push-pull rod 262 and the short push-pull rod 272 in the switch component 2.

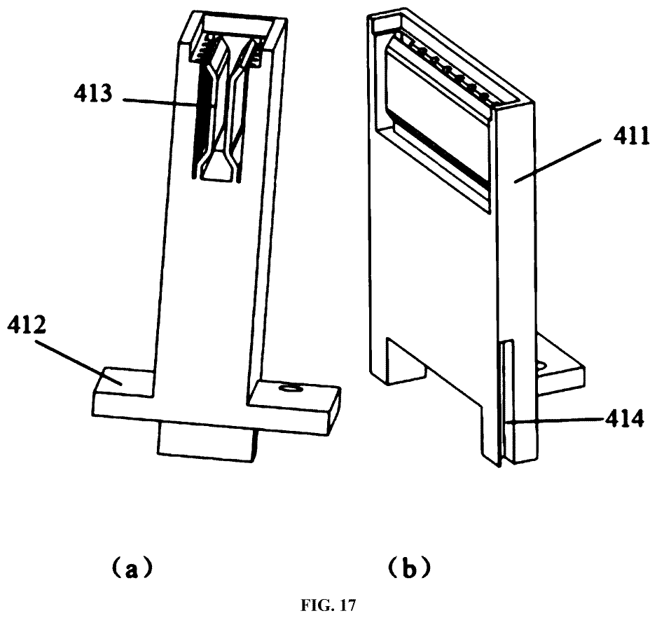

As shown in FIGS. 16 and 17, the photovoltaic module connection electrode component 4 includes a socket electrode 41, a diode 42, and a welding electrode 43. One end of the diode 42 is connected to the socket electrode 41, and the other end is connected to the welding electrode 43. The socket electrode 41 is composed of an outer shell 411, an electrode 412, and a spring electrode sheet 413. The outer shell 411 is provided with a fifth slot 414, and the fifth slot 414 is used for connecting with the main housing 11.

As shown in FIG. 2 to 17, the switch component 2, the cable storage component 3, and the photovoltaic module connection electrode component 4 are all installed in the housing 1; the switch rotating shaft 21 of the switch component 2 is connected to the main housing 11 on the shell 311 of the cable storage component 3; the long push-pull rod 262 and the short push-pull rod 272 of the switch component 2 are installed in the first limit slot 3113 and the second limit slot 3114 on the shell 311 of the cable storage component 3, respectively; the photovoltaic module connection electrode component 4 is installed in the first slot 111 of the main housing 11; the bottom of the socket electrode 41 is connected to the main housing 311, the top is connected to the cable socket 122 on the cover body 12, and the welding electrode 43 is connected to the copper bar electrode 25 in the switch component 2.

As shown in FIG. 2, the working principle of the cable-storage-type photovoltaic module junction box is as follows: the positive and negative busbar inlets 114 of the photovoltaic module are used for accessing the busbars of the photovoltaic module, and the busbars are connected to the electrode 412 on the socket electrode 41 and the welding electrode 43, respectively. During the production and transportation of the module, the plug 3221 on the cable 322 is installed in the fixing slot 124 on the cover body 12; the switch rotating shaft 21 in the switch component 2 is turned to the side of the cable socket 122 on the cover body 12. At this time, the short connecting rod 24 and the long connecting rod 23 drive the long isolating knife 26 and the short isolating knife 27 to move in the first limit slot 3113 and the second limit slot 3114 on the shell 311, respectively, so that the first electrode 261 of the long isolating knife 26 and the second electrode 271 of the short isolating knife 27 are separated from the leaf spring slots 3261 provided at both ends of the rotating electrode 326 in the cable storage component 3, thereby breaking the circuit.

As shown in FIG. 3, when the module is installed on the site of the photovoltaic power station, the cable 322 is pulled out and connected to the cable socket 122 on the cover body 12 of the junction box on the next photovoltaic module. The switch rotating shaft 21 in the switch component 2 is turned to the side of the cable outlet 121 on the cover body 12. At this time, the short connecting rod 24 and the long connecting rod 23 drive the long isolating knife 26 and the short isolating knife 27 to move in the first limit slot 3113 and the second limit slot 3114 on the shell 311, respectively, so that the first electrode 261 of the long isolating knife 26 and the second electrode 271 of the short isolating knife 27 are in contact with the leaf spring slots 3261 provided at both ends of the rotating electrode 326 in the cable storage component 3, thereby connecting the circuit.

During the production process of the module, the junction box is pasted to the outlet position of the busbar of the photovoltaic module with silica gel. The busbar of the module is connected to the welding electrode 43 in the photovoltaic module connection electrode component 4 and the electrode 412 in the socket electrode 41 through the positive and negative busbar inlets 114 of the photovoltaic module in the housing 1; the switch rotating shaft 21 in the switch component 2 is turned to the side of the cable socket 122 on the cover body 12 to disconnect the circuit, and the plug 3221 on the cable 322 is installed in the fixing slot 124 on the cover body 12.

When the photovoltaic module is transported to the photovoltaic power station for installation, the cable 322 is pulled out and connected to the cable socket 122 on the cover body 12 of the junction box on the next photovoltaic module. The switch rotating shaft 21 in the switch component 2 is turned to the side of the cable outlet 121 on the cover body 12 to connect the circuit.

For those skilled in the art, it is obvious that the present application is not limited to the details of the above exemplary embodiments, and the present application can be implemented in other specific forms without departing from the spirit or basic characteristics of the present application. Therefore, from any point of view, the embodiments should be regarded as exemplary and non-limiting. The scope of the present application is defined by the appended claims rather than the above description, and thus it is intended to include all changes that fall within the meaning and scope of the equivalent elements of the claims in the present application. Any reference signs in the claims shall not be regarded as limiting the claimed claims.

In addition, it should be understood that although this specification is described in accordance with implementation modes, not each implementation mode only contains an independent technical solution. This way of describing the specification is only for clarity. Those skilled in the art should regard the specification as a whole, and the technical solutions in each embodiment can also be properly combined to form other implementation modes that can be understood by those skilled in the art.

What is claimed is:

1. A cable-storage-type photovoltaic module junction box comprising: a housing, a switch component, a cable storage component, and a photovoltaic module connection electrode component.

2. The cable-storage-type photovoltaic module junction box according to claim 1, wherein the housing comprises a main housing, a cover body, and an internal partition; the main housing is provided with a first slot for fixing the photovoltaic module connection electrode component, a second slot for fixing a copper bar of the switch component, a third slot for fixing the cable storage component, positive and negative busbar inlets of the photovoltaic module, and reinforcing ribs; the cover body is provided with a cable outlet, a cable socket, a connection port of the switch component and a fixing slot; the internal partition is provided with a socket port and heat dissipation grilles.

3. The cable-storage-type photovoltaic module junction box according to claim 1, wherein the switch component comprises a switch rotating shaft, a handle kit, a long connecting rod, a short connecting rod, a copper bar electrode, a long isolating knife, a short isolating knife, and a flexible connection cable; one end of the long connecting rod and one end of the short connecting rod are both connected to the switch rotating shaft, and the other end of the long connecting rod is connected to the short isolating knife while the other end of the short connecting rod is connected to the long isolating knife, the handle kit is sleeved on the switch rotating shaft; one end of the flexible connection cable is connected to the copper bar electrode, and the other end of the flexible connection cable is connected to the long isolating knife and the short isolating knife, respectively.

4. The cable-storage-type photovoltaic module junction box according to claim 1, wherein the long isolating knife is composed of a first electrode and a long push-pull rod; one end of the long push-pull rod is provided with a first slotted hole for connecting to the short connecting rod; the short isolating knife is composed of a second electrode and a short push-pull rod; one end of the short push-pull rod is provided with a second slotted hole for connecting to the long connecting rod.

5. The cable-storage-type photovoltaic module junction box according to claim 1, wherein the cable storage component comprises an outer shell and a retractable cable drum; the outer shell comprises a shell body and a cover plate, both the shell body and the cover plate are made of insulating materials; the retractable cable drum comprises a drum shell, a cable, a volute spring, a spring cover plate, a shaft, and a rotating electrode; one end of the cable is connected to the rotating electrode, and the other end is provided with a plug; the rotating electrode is a hollow rotatable member, and both ends of the hollow rotatable member are provided with leaf spring slots; the drum shell is provided with a cable outlet and a fixing port for the volute spring; the shell body is provided with a fourth slot for installing the shaft, a fixed shaft for installing the switch component, and a first limit slot and a second limit slot for limiting the stroke of the long push-pull rod and the short push-pull rod in the switch component.

6. The cable-storage-type photovoltaic module junction box according to claim 1, wherein the photovoltaic module connection electrode component comprises a socket electrode, a diode, and a welding electrode; one end of the diode is connected to the socket electrode, and the other end of the diode is connected to the welding electrode; the socket electrode is composed of an outer shell, an electrode, and a spring electrode sheet; the outer shell is provided with a fifth slot for connecting to the main housing.
